(19) United States
(12) Patent Application Publication
(10) Pub. No.: US 2022/0105455 A1
(43) Pub. Date: Apr. 7, 2022

(54) MULTISTAGE FILTER CARTRIDGE

(71) Applicant: Protect Plus, LLC, Hickory, NC (US)

(72) Inventors: Glenn F. CUEMAN, Denver, NC (US); Fred GEYER, Rensselaer, IN (US); Arvind S. PATIL, Davidson, NC (US); Ronn PRICE, Terell, NC (US)

(21) Appl. No.: 17/061,720

(22) Filed: Oct. 2, 2020

(51) Int. Cl. B01D 39/16; B01D 35/30

(52) U.S. Cl. CPC B01D 39/1661; B01D 2201/29; B01D 2201/302; B01D 35/30

(57) ABSTRACT

A multistage filter cartridge includes a generally circular outer filtering stage composed of a melt blown polypropylene material having an outer surface and an inner surface and an inner diameter and an outer diameter, and a generally circular inner filtering stage composed of carbon and a binder material forming a carbon block having an outer surface and an inner surface and an inner diameter and an outer diameter. A first void is disposed between the inner surface of the outer layer and the outer surface of the inner layer, and a second void within the inner surface of the carbon block, said voids being filled with granular, filtering material.

### FIELD OF THE INVENTION

The present invention relates generally to a multistage filter cartridge, and more generally a multistage filter cartridge containing a first filtering stage composed of a non-woven, such as a melt blown polypropylene material which forms a structural component, and a second filtering stage composed of a carbon and a binder material, forming a carbon block, a void disposed between the melt blown polypropylene material and second filtering state which contains granular filtering material with contaminant removal capacity, wherein the multistage filter cartridge removes a high concentration of contaminants, such as lead, at a high flow rate.

### BACKGROUND OF THE INVENTION

According to the United States' Environmental Protection Agency (“EPA”), the presence of lead, even in small concentrations such as one ppb, is undesirable, especially for pregnant women and children, as it affects brain development and is bio-accumulative over the lifetime. Currently, the EPA has established an Action Level of 15 ppb in the municipally treated drinking water. Once this action level is exceeded due to corrosion and leaching of pipes and plumbing fixtures containing lead, EPA requires the costly replacement of these lead service lines. Of roughly 4000 large community water systems that supply drinking water to 82% of the United States population, about 2000 water systems supplied water exceeding 15 ppb in 2017. Many of these community water systems also provide drinking water to schools, hospitals and day care facilities. The problem of excessive lead levels at these public schools and day care centers have led to 12 states placing regulations on testing of lead in drinking water and an additional five states have pending legislation. There is a need for a filter with the ability to remove lead at fast flowrates, diminishing the need to make very large, impractical filter installations at these facilities.

Prior art water filter cartridges remove lead by absorption and ion exchange mechanisms that take high contact time or very slow flow rates, making it difficult to attain an acceptable flowrate in a reasonably sized filter which provides the acceptable removal of contaminants, such as lead, through the filter with acceptable capacity. As such, the multistage filter cartridge of the present invention allows for the effective removal of lead at high flow rates, with acceptable capacity, in a reasonably sized filter..

### BRIEF SUMMARY OF THE INVENTION

According to an embodiment of the present invention, a multistage filter cartridge includes an outer filtering structural stage composed of a non-woven, preferably melt blown, material, an inner filtering stage composed of a carbon and a binder material forming a carbon block, and a void disposed between the outer filtering stage and the inner filtering stage filled with granular filtering material.

According to another embodiment of the present invention, the multistage filter cartridge wherein the non-woven melt blown material is generally circular with a hollow center portion, and the inner filtering stage is disposed within the hollow center portion and spaced apart from the outer filtering stage, forming the void between the inner filtering stage and the outer filtering stage.

According to yet another embodiment of the present invention, the multistage filter cartridge that includes granular filtering material within the void.

According to yet another embodiment of the present invention, the multistage filter cartridge includes an antimicrobial agent in the non-woven material.

According to yet another embodiment of the present invention, the multistage filter cartridge includes a scavenger material as the granular filtering material.

According to yet another embodiment of the present invention, the multistage filter cartridge includes an inner filtering stage composed of activated carbon and a binder.

According to yet another embodiment of the present invention, the multistage filter cartridge includes an inner filtering stage that includes a scavenger material.

According to yet another embodiment of the present invention, the multistage filter cartridge includes an outer filtering stage composed of a melt blown polypropylene material having an outer surface and an inner surface, an inner filtering stage composed of carbon and a binder material forming a carbon block having an outer surface and an inner surface, and a void disposed between the outer filtering stage and the inner filtering stage.

According to yet another embodiment of the present invention, the multistage filter cartridge includes a first end cap disposed on a top side of the multistage filter cartridge and a second end cap disposed on a bottom side of the multistage filter cartridge.

According to yet another embodiment of the present invention, the multistage filter cartridge includes a filtering material contained within the void.

According to yet another embodiment of the present invention, the multistage filter cartridge includes granular scavenger material within the void.

According to yet another embodiment of the present invention, the multistage filter cartridge includes an antimicrobial agent within the melt blown polypropylene material of the outer filtering stage.

According to yet another embodiment of the present invention, the multistage filter cartridge includes granular carbon contained within the void.

According to yet another embodiment of the present invention, the multistage filter cartridge includes a metal scavenging additive within the melt blown polypropylene material of the outer filtering stage

According to yet another embodiment of the present invention, the multistage filter cartridge includes a generally circular outer filtering stage composed of a melt blown polypropylene material having an outer surface and an inner surface and an inner diameter and an outer diameter, and a generally circular inner filtering stage composed of carbon and a binder material forming a carbon block having an outer surface and an inner surface and an inner diameter and an outer diameter. A first void is disposed between the inner surface of the outer layer and the outer surface of the inner layer, and a second void within the inner surface of the carbon block.

According to yet another embodiment of the present invention, the multistage filter cartridge includes a granular scavenger material within the first void.

According to yet another embodiment of the present invention, the multistage filter cartridge can reduce the lead concentration in water from 150 ppb to less than 1 ppb for at least 90,000 gallons of water at a flow rate of 8 gallons per minute.

### BRIEF DESCRIPTION OF THE DRAWINGS

The present invention is illustrated and described herein with reference to the various drawings, in which like reference numbers denote like method steps and/or system components, respectively, and in which:

FIG. 1 is a sideview of the multistage filter cartridge;

FIG. 2 is a cut-away sideview of the multistage filter cartridge;

FIG. 3 is a top view of the multistage filter cartridge without the end caps;

FIG. 4 is a side perspective view of the multistage filter cartridge;

FIG. 5 is a top view of the first end cap;

FIG. 6 is a bottom view of the second end cap;

FIG. 7 is a perspective view of an exemplary pressure vessel;

FIG. 8 is a side view of an exemplary pressure vessel; and

FIG. 9 is a side view of an exemplary pressure vessel with the multistage filter cartridge disposed within the cavity.

### DETAILED DESCRIPTION OF THE INVENTION

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

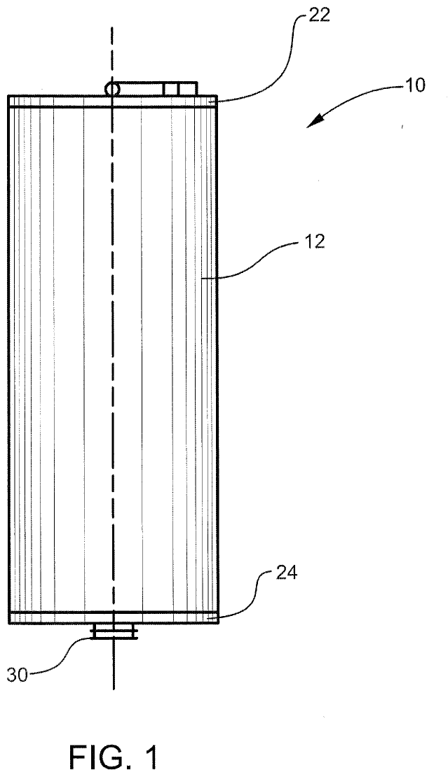

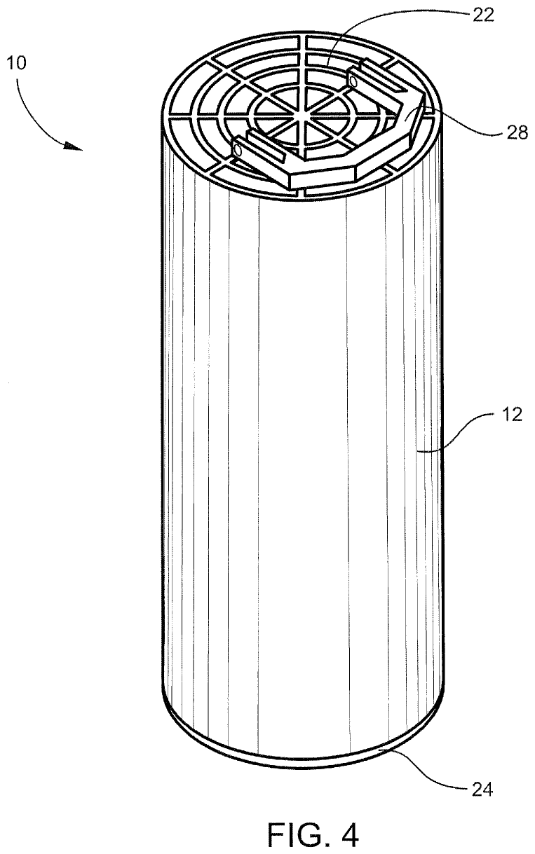

Referring now specifically to the drawings, as illustrated in FIGS. 1-4 a multistage filter cartridge is shown generally at reference numeral 10 for removing lead and other contaminants from water. The multistage filter cartridge 10 is designed as a Point of Entry (POE) filter that have a larger in capacity and are installed to produce large quantities of treated water, compared to Point of Use (POU) filters generally used to treat smaller quantities of water and installed in a kitchen or sink. However, the multistage filter cartridge 10 disclosed herein could be used as a POU filter. The multistage filter cartridge 10 provides filtered drinking water suitable for consumption.

The multistage filter cartridge 10 includes an outer filtering stage 12, an inner filtering stage 14, and a first void 16 disposed between the outer filtering stage 12 and the inner filtering stage 14. A second void 18 is disposed within the inner filtering stage 14. The outer filtering stage 12 is circular shaped having an outer surface, an inner surface, an inner diameter, and an outer diameter. The outer filtering stage 12 has a top end and a bottom end and is porous to allow water to pass through. The outer filtering stage 12 has a hollow center portion within the inner diameter. The outer filtering stage 12 is composed of a non-woven material, such as a poly melt blown layer, and specifically composed of a melt blown polypropylene material. The melt blown polypropylene material may be made from Exxon Polypropylene 7143KnE1 polymer and designed to remove larger debris and remove and absorb lead and other contaminants from the water passing through.

An antimicrobial agent may be incorporated into the outer filtering stage 12. The antimicrobial agent may be incorporated into the melt blown polypropylene material during the extrusion of the fibers.

A scavenger material may also be incorporated into the melt blown polypropylene material. In one embodiment, the scavenger material may be a metal scavenging additive named SIRT SZT, supplied by Surfatas Corporation, LLC, 11515 Vanstory Drive Suite 120, Huntersville, N.C. 28078. The scavenger material may have a bulk density of between about 0.2 g/mL to about 1 g/mL, more preferably between about 0.3 g/ML to about 8 g/mL, and most preferably between about 0.4 g/mL to about 0.7 g/mL In another embodiment, the scavenger material is a lead scavenger, such as titanium dioxide, zeolite, activated alumina, zirconia oxide or hydroxide.

The outer filtering stage 12 may filter larger material and remove and absorb sediment. The thickness of the outer filtering stage 12 may be between about 0.3 inches (1 cm) to about 4.0 inches (10.16 cm) and preferably between about 0.60 inches (1.50 cm) to about 2.0inches (5.08 cm).

The inner filtering stage 14 is circular shaped having an outer surface, an inner surface, an inner diameter, and an outer diameter. The inner filtering stage 14 has a top end and a bottom end and is porous to allow water to pass through. The inner filtering stage 14 has a hollow center portion within the inner diameter, forming the second void 18 disposed within the inner surface of the inner filtering stage 14. The inner filtering stage 14 is composed of carbon particles and binder material forming a carbon block. The binder material is dispersed with the carbon particles and the binder is preferably hydrophobic. The carbon particles may be an activated carbon or an activated catalytic carbon. The carbon block of the inner filtering stage 14 has an outer diameter of between about 0.5 inches to about 10 inches, more preferably between about 2 inches to about 8 inches, and most preferably between about 3 inches to about 6 inches. The inner diameter of carbon block of the inner filtering stage 14 is between about 0.1 inches to about 4 inches, more preferably between about 0.5 inches to about 3 inches, and most preferably between about 1 inch to about 2 inches. The height of the carbon block of the inner filtering stage 14 is between about 10 inches to about 35 inches, more preferably between about 15 inches to about 30 inches, and most preferably between about 18 inches to about 25 inches. The carbon block may be manufactured by CBTech of Las Vegas, Nev. and designed to remove and absorb lead and other contaminants from the water passing through.

A scavenger material may also be incorporated into the carbon block of the inner filtering stage 14. In one embodiment, the scavenger material may be a metal scavenging additive named SIRT SZT, supplied by Surfatas Corporation, LLC, 11515 Vanstory Drive Suite 120, Huntersville, N.C. 28078.

The first void 16 is disposed between the inner surface of the outer filtering stage 12 and outer surface of the inner filtering stage 14. The first void 16 separates the outer filtering stage 12 from the inner filtering stage 14 and the outer filtering stage 12 is separate and does not contact the inner filtering stage 14. The first void 16 may contain a filtering material 20 and is porous allowing water to pass through. The filtering material 20 may be a scavenger material, a carbon, or a combination of the above. A granular or beaded antimicrobial agent may also be contained within the first void 16. It can be a beaded antimicrobial agent called C 150 Ag from Surfatas Corporation, LLC, 11515 Vanstory Drive, Suite 120, Huntersville, N.C. 28078. If a scavenging material or antimicrobial agent is disposed in the first void 16, it is preferably in granular or beaded form. The scavenger material may be a metal scavenging additive named SIRT SZT, supplied by Surfatas Corporation, LLC, 11515 Vanstory Drive Suite 120, Huntersville, N.C. 28078. Preferably, the scavenging material in the first void 16 is SIRT SZP-I000 beads sold by Surfatas Corporation, LLC and designed to remove and absorb lead and other contaminants from the water passing through. The first void 16 may contain between about 2 lbs. to about 20 lbs., more preferably between about 5 lbs., to about 15 lbs., and most preferably between about 8 lbs. to about 12 lbs of the scavenging material within the first void 16.

The filtering material 20, may be in granular form, and not contain a binder material. Since the filtering material 20 does not contain a binder, the entire surface area of the filtering material 20 may be exposed to the water and not blocked or impeded by a binder material 20. As such, there is more exposed surface area on the filtering material 20 for the absorption of the water containing the effluent and for penetration into the pores.

The first void 16 has a total volume of between about 20 cubic inches to about 50 cubic inches, more preferably about 25 cubic inches to about 45 cubic inches, and most preferably 30 cubic inches to about 40 cubic inches. When carbon is the filtering material 20, the carbon may be contained within the first void 16 in its free form, meaning the carbon is not bound together with a binder, such as a polymeric resin. Alternatively, the carbon contained in the first void 16 may be combined with a binder forming a carbon block. In this embodiment, the first void 16 would contain a carbon block that is preferably circular and adjacent, and possibly engaged, to the inner surface of the outer filtering stage 12 and outer surface of the inner filtering stage 14. The carbon block in the first void 16 would be separate from the carbon block that preferably comprises the inner filtering stage 14. The carbon may also be an activated carbon or an activated catalytic carbon. A catalytic activated carbon that may be used within the first void 16 is sold under the name Haycarb Corp. RWC 1101 supplied by NGF, 1030 E. Elm Street, Rensselaer, Ind. 47978 of 12×40 mesh.

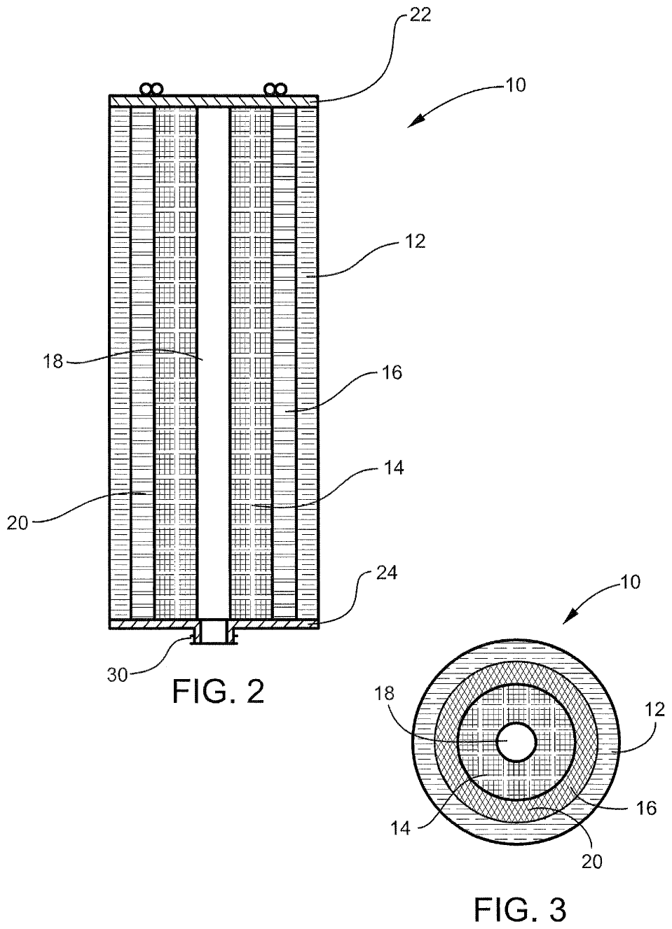

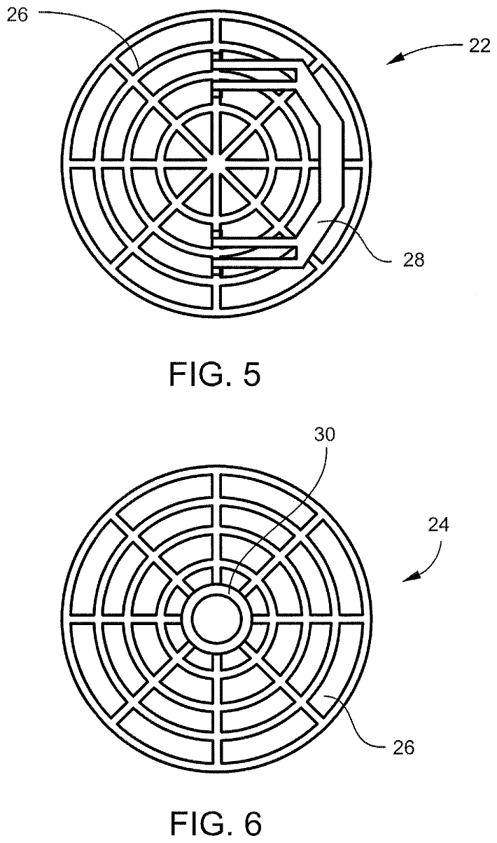

As illustrated in FIGS. 2, 5 and 6, a first end cap 22 is positioned on the top side of the multistage filter cartridge 10 and a second end cap 24 is positioned on the bottom side of the multistage filter cartridge 10. The first end cap 22 and the second end cap 24 have a top portion and a bottom portion. The first end cap 22 and the second end cap 24 contains a plurality of openings 26 that extend from the top portion to the bottom portion. The end caps 22, 24 retain the outer filtering stage 12 and the inner filtering stage 14 in its appropriate position within the multistage filter cartridge 10. The end caps 22, 24 retain the filtering material 20 within the first void 16 and prevents the filtering material 20 from escaping from the multistage filter cartridge 10 through the top side or the bottom side. The first end cap 22 also contains a handle 28 engaged to the top portion of the first end cap 22, for allowing the filter cartridge 10 to be easily removed from a housing or vessel.

The bottom portion of the first end cap 22 is engaged to the top end of the outer filtering stage 12. The bottom portion of the first end cap 22 may also be engaged to the top end of the inner filtering stage 14, and the bottom portion of the first end cap 22 retains the filtering material 20 within the first void 16 and prevents the filtering material 20 from escaping from the multistage filter cartridge 10 through the top side. The bottom portion of the second end cap 24 is engaged to the bottom end of the outer filtering stage 12. The bottom portion of the second end cap 24 may also be engaged to the bottom end of the inner filtering stage 14, and the bottom portion of the second end cap 24 retains the filtering material 20 within the first void 16 and prevents the filtering material 20 from escaping from the multistage filter cartridge 10 through the bottom side.

The first end cap 22, second end cap 24, and the outer surface of the outer filtering stage 12 collectively form the external structure of the multistage filter cartridge 10. In other words, the outer filtering stage 12, which is a filtering element, provides the external surface of the multistage filter cartridge 10 and does not require a separate housing to encompass the multistage filter cartridge 10. The second end cap 24 contains a nipple 30 extending outward from the second end cap 24. The nipple 30 may be externally threaded for receiving a correspondingly threaded device. The nipple 30 extends from the top portion to the bottom portion of the second end cap 24 and in fluid communication with the second void 18.

The multistage filter cartridge 10 may contain between 10 to 200 fold reductions. The multistage filter cartridge 10 reduces from 150 ppb to less than 1 ppb of lead within water, wherein the multistage filter cartridge 10 has a total capacity of 108,000 gallons at a flow rate of 8 gpm.

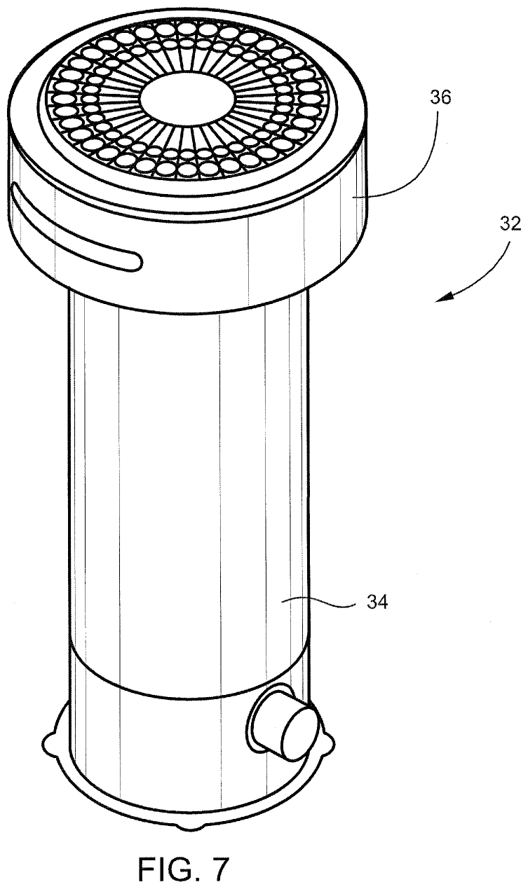

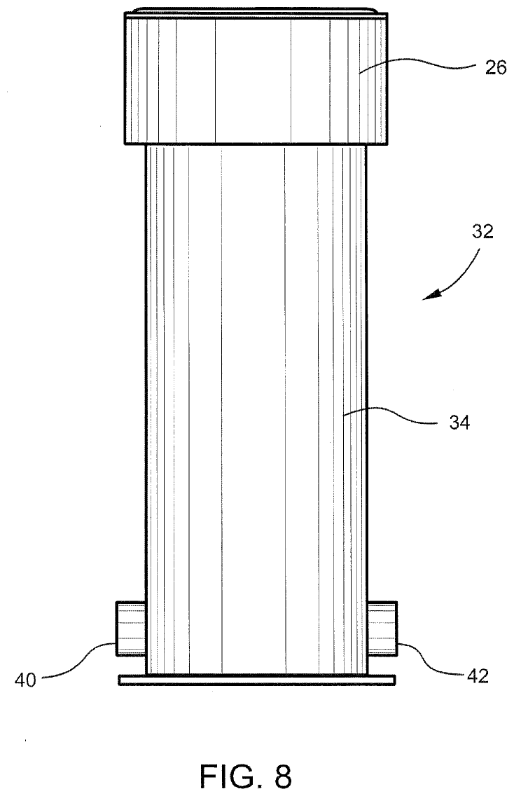

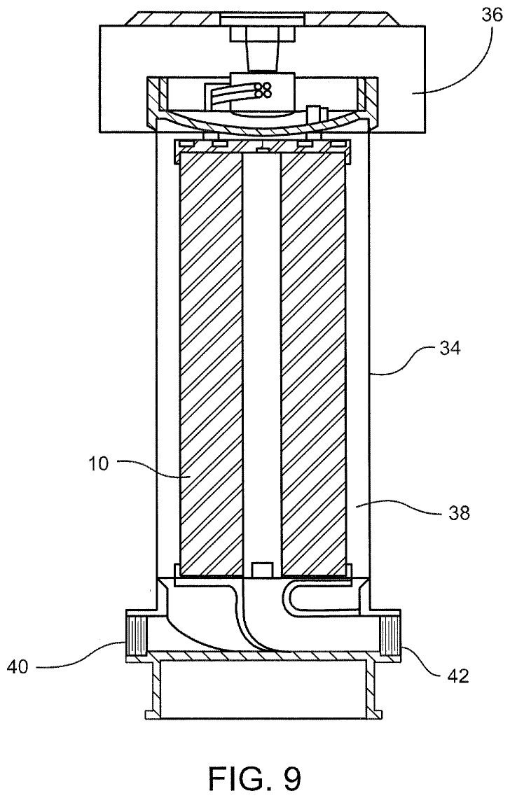

During operation, the multistage filter cartridge 10 is contained within a pressure vessel 32 or similar housing. As illustrated in FIGS. 7-9, the pressure vessel 32 has a base portion 34 and a top portion 36. The base portion 34 is generally cylindrical and contains a hollow cavity 38 for receiving the multistage filter cartridge 10. The bottom portion of the base portion 34 contains an inlet 40 and an outlet 42, that are spaced apart and disposed on opposite sides of the pressure vessel 32. The nipple 30 of the second end cap 34 is engaged to the outlet of the pressure vessel 32.

The top portion 36 is removably attached to the upper portion of the base portion 34. The top portion 36 provides access to the cavity 38 of the base portion 34 for allowing the multistage filter cartridge 10 to be inserted into the cavity 38 and removed from the cavity 38 of the base portion 34.

During use and when the multistage filter cartridge 10 is contained within a pressure vessel 32 or similar housing, the water containing the effluent that is to be treated enters the inlet 40 of the pressure vessel 32, and is forced through the outer surface of the outer filtering stage 12 and through the outer filtering stage 12. The water exits the inner surface of the outer filtering stage 12 after completing the first and initial stage of the filtering process. Once the water exits the inner surface of the outer filtering stage 12, the water enters the first void 16 and contacts the filtering material 20. The water is forced through the first void 16, where it contacts the surface of the filtering material 20 and can be absorbed within the filtering material 20. Afterwards, the water is forced into the outer surface of the inner filtering stage 14 and through the inner filtering stage 14. The water exits the inner surface of the inner filtering stage 14 and into the second void 18. The water flows downward through the second void 18 and exits the multistage filter cartridge 10 through the nipple 30 of the second end cap and exits the exit of the pressure vessel 32.

Definitions

The term “activated carbon” as used herein, means a highly porous carbon having a random or amorphous structure with small, low-volume pores, increasing the surface area available for the removal and absorption of containments in water, such as lead.

The term “catalytic activated carbon” as used herein, means carbon materials have been contacted or otherwise exposed to nitrogen-containing compounds and used to remove contaminants, such as chloramines, from water.

The term “binder” as used herein, means a material that promotes cohesion of aggregates or particles. Many binders may be used, for example, thermoplastic binder, thermo-set binder, etc. The term “binder” thus includes polymeric and/or thermoplastic materials that are capable of softening and becoming “tacky” at elevated temperatures and hardening when cooled. Such thermoplastic binders include, but are not limited to, end-capped polyacetals, such as poly(oxymethylene) or polyformaldehyde, poly(trichloroacetaldehyde), poly(n-valeraldehyde), poly(acetaldehyde), poly(propionaldehyde), and the like; acrylic polymers, such as polyacrylamide, poly(acrylic acid), poly(methacrylic acid), poly(ethyl acrylate), poly(methyl methacrylate), and the like; fluorocarbon polymers, such as poly(tetrafluoroethylene), perfluorinated ethylene-propylene copolymers, ethylene-tetrafluoroethylene copolymers, poly(chlorotrifluoroethylene), ethylene-chlorotrifluoroethylene copolymers, poly(vinylidene fluoride), poly(vinyl fluoride), and the like; polyamides, such as poly(6-aminocaproic acid) or poly(c-caprolactam), poly(hexamethylene adipamide), poly(hexamethylene sebacamide), poly(l1-aminoundecanoic acid), and the like; polyaramides, such as poly(imino-1,3-phenyleneiminoisophthaloyl) or poly(m-phenylene isophthalamide), and the like; parylenes, such as poly-p-xylylene, poly(chloro-p-xylylene), and the like; polyarylene oxides; polyarylates; polyaryl ethers, such as poly(oxy-2,6-dimethyl-1,4-phenylene) or poly(p-phenylene oxide), and the like; polysulfones; polyaryl sulfones, such as poly(oxy-1,4-phenylenesulfonyl-1,4-phenyleneoxy-1,4-phenylene-isopropylidene-1,4-phenylene), poly-(sulfonyl-1,4-phenyleneoxy-1,4-phenylenesulfonyl-4,4′-biphenylene), and the like; polycarbonates, such as poly(bisphenol A) or poly(carbonyldioxy-1,4-phenyleneisopropylidene-1,4-phenylene), and the like; polyesters, such as poly(ethylene terephthalate), poly(tetramethylene terephthalate), poly(cyclohexylene-1,4-dimethylene terephthalate) or poly(oxymethylene-1,4-cyclohexylenemethyleneoxyterephthaloyl), and the like; polyaryl sulfides, such as poly(p-phenylene sulfide) or poly(thio-1,4-phenylene), and the like; polyimides, such as poly(pyromellitimido-1,4-phenylene), and the like; polyolefins, such as polyethylene, polypropylene, poly(l-butene), poly(2-butene), poly(l-pentene), poly(2-pentene), poly(3-methyl-l-pentene), poly(4-methyl-1-pentene), and the like; vinyl polymers, such as poly(vinyl acetate), poly(vinylidene chloride), poly(vinyl chloride), polyvinlyl halides, polyvinyl esters, polyvinyl ethers, polyvinyl sulfates, polyvinyl phosphates, polyvinyl amines and the like; diene polymers, such as 1,2-poly-1,3-butadiene, 1,4-poly-1,3-butadiene, polyisoprene, polychloroprene, and the like; polystyrenes; copolymers of the foregoing, such as acrylonitrile-butadiene-styrene (ABS) copolymers, and the like; polyoxidiazoles; polytriazols; polycarbodiimides; phenol-formaldehyde resins; melamine-formaldehyde resins; formaldehydeureas; and the like; co-polymers and block interpolymers thereof; and derivatives and combinations thereof.

The thermoplastic binders further include ethylenevinyl acetate copolymers (EVA), ultra-high molecular weight polyethylene (UHMWPE), very high molecular weight polyethylene (VHMWPE), nylon, polyethers such as polyethersulfone, ethylene-acrylic lic acid copolymer, ethylene-methacrylic acid copolymer, ethylene-methylacrylate copolymer, polymethylmethacrylate, polyethylmethacrylate, polybutylmethacrylate, and copolymers/mixtures thereof.

### Test Procedures

The testing procedures were conducted using a scaled down version of the present invention. This scaled down version was used and tested by an outside certifying agency. The testing of a full-scale device in excess of 100,00 gallons would take an inordinate amount of time for the testing agency. The scaled down version is a ⅓ scale and the results can be multiplied by three to arrive at the actual performance of a full unit.

The specifications for testing are indicated in Table 1 below:

TABLE 1
Specifications of testing

| | |
|---|---|
| Number of Units | 2 |
| Cycle | 50/50 |
| Rated Capacity | 20,000 gallons, yes PID, tested to 120% |
| | of capacity the unit was still passing |
| | after the 20,000 gallon capacity was |
| | reached further samples were taken to a |
| | total of 36,000 gallons |
| Conditioning | The cartridges were soaked for two hours, |
| | water was then run through the system for |
| | half an hour at 60 psi, NSF 53 lead 8.5 |
| | water was used for this portion of conditioning. |
| Flowrate | 2.67 gpm |
| Sampling | Sampled at 10 unit volume, 25%, 50% 75%, |
| | 100%, 120% of capacity |
| Deviations from standard | After 36,000 gallons was reached, the unit |
| | was challenged with an influent lead level |
| | of 1000 ppb, 10 unit volumes was passed |
| | through the unit and then a sample was taken. |
| | After 24 hours another 10 unit volumes of |
| | 1000 ppb lead challenge was passed through |
| | the unit and another sample was taken |
| | One unit volume is 3.7 gallons, for a total of |
| | 37 gallons at each sample point |

Influent water was prepared per the specifications in NSF/ANSI 53 Section 7.4.3.5.2.3 as shown in Table 2 below:

TABLE 2
Water Characteristics

| pH | 8.3-8.6 | |
|---|---|---|
| Temperature | 20 ± 2.5 | degrees C. |
| Total Chlorine | 0.5 ± 0.25 | mg/L |
| Hardness | 90-110 | mg/L |
| Alkalinity | 90-110 | mg/L |
| Total Lead | 120-180 | ppb |
| Percent Particulate Lead | 10-50% | |
| (single point) | | |
| Percent Fine Particulate | | |
| Lead | | |

| | |
|---|---|
| Percent Particulate | 200/6-400/0 |
| (Average) | |

### EXAMPLES

A multistage filter media is prepared and tested by the following methods in a non-limiting example.

A filter in accordance with the present invention was tested. The filter consists of an 8″ diameter and 21″ long overall element that has the outer most 0.75″ circumferential layer of melt blown polypropylene material made from Exxon Polypropylene 7143KnE1 Polymer supplied by AMBF, 1030 E. Elm Street, Rensselaer, Ind. 47978.The inner and outer surfaces of this melt blown polypropylene material are wetted by water and their respective inner and outer surface areas exposed to water are 527.52 and 428.61 square inches. The melt blown polypropylene material also contains 15% of Metal Scavenging additive called SIRT SZT supplied by Surfatas Corp. A carbon block, having an O.D. and I.D. of 4.5″ and 1.5″ respectively and the height of 21″ is positioned inside the melt blown polypropylene material and separated from the melt blown polypropylene material by a 1″ diameter void. The carbon block is a combination of carbon and a polymeric resin manufactured by CBTech of Las Vegas, Nev. The contains a beaded metal scavenger called SIRT-SZP-IOOO bead (supplied by Surfatas Corp.), having the bulk density of 0.68 g/ml. The total volume of the cavity is 33 cubic inches, which holds about 10 lb. of SIRT SZP-IOOO beads.

TABLE 3
Influent and effluent lead levels

| Samples | | | Influent % | | |
|---|---|---|---|---|---|
| Required | | Influent % | Fine | | |
| by Standard | Influent T | Particulate | Particulate | Effluent | Effluent |
| (gallons) | (ppb) | (ppb) | (ppb) | (ppb) | (ppb) |
| 10 unit volumes | 133 | | 89% | 0.537 | 0.976 |
| 5,000 | 142 | | 87% | 0.238 | 0.26 |
| | 159 | | | 0.244 | x |
| | 159 | | | x | 0.282 |
| 15,000 | 176 | | | 0.193 | 0.395 |
| 20,000 | 168 | | | ND | ND |
| 24,000 | 141 | | | 0.385 | 0.434 |

Note:
Detection limit for lead is 0.13 ppb
*each sample was on a different flow totalizer and at 10000 gal they were not synced.

TABLE 4
Samples taken after original capacity was reached

| Supplemental | | | | | |
|---|---|---|---|---|---|
| Samples taken | | | | | |
| after original | | | Influent % | | |
| capacity | | Influent % | Fine | | |
| was reached | Influent T | Particulate | Particulate | Effluent | Effluent |
| (gallons) | (ppb) | (ppb) | (ppb) | (ppb) | (ppb) |
| 30000 | 128 | | 40 | 0.269 | 0.169 |
| 34000 | 162 | | 47 | 1.48 | 0.711 |
| 36000 | 138 | 14% | 55 | 0.666 | 0.579 |

Note:
Detection limit for lead is 0.13 ppb

TABLE 5
Average Influent, Effluent and Percent
Reduction (Including 36,000 gal data)

| | | Standard |
|---|---|---|
| | Results | Requirements |
| Ave Influent (Inf) (ppb) | 150.6 | 150 ± 15 |
| Ave Percent Particulate Influent | | |
| Ave Effluent (Eff) E1 (ppb) | 0.502 | Maximum 10 |
| Ave Effluent (Eff) E2 (ppb) | 0.476 | Maximum 10 |
| Maximum Effluent (ppb) | 1.48 | 10 |
| Ave % Reduction E1 | 99.7 | |
| Ave % Reduction E2 | 99.7 | |
| Ave % Reduction Both Samples | 99.7 | |
| Minimum % Reduction | 99.1 | |

TABLE 6
1000 ppb influent lead challenge sample points

| 1000 ppb | | | Influent % | | |
|---|---|---|---|---|---|
| challenge | | Influent % | Fine | | |
| samples | Influent T | Particulate | Particulate | Effluent | Effluent |
| (gallons) | (ppb) | (ppb) | (ppb) | (ppb) | (ppb) |
| Day 1 | 994 | 81 | 1.86 | 0.471 | 0.326 |
| Day 2 | 937 | 80 | 1.61 | 0.368 | 0.183 |

As set forth above, the reduction of 150 ppb lead effluent to less than 1 ppb lead influent at a flow rate of 2.67 gpm. On a full-scale multistage filter cartridge of the present invention, the multistage filter cartridge 10 reduces 150 ppb to less than 1 ppb in effluent for a total capacity of 108,000 gallons at the flow rate of 8 gpm.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. A multistage filter cartridge, comprising:
an outer filtering stage composed of a non-woven material;
an inner filtering stage composed of a carbon and a binder material forming a carbon block; and
a void disposed between the outer filtering stage and the inner filtering stage containing filtering material.

2. The multistage filter cartridge according to claim 1, wherein the non-woven material is generally circular with a hollow center portion, and the inner filtering stage is disposed within the hollow center portion and spaced apart from the outer filtering stage, forming the void between the inner filtering stage and the outer filtering stage.

3. The multistage filter cartridge according to claim 1, wherein the void contains granular filtering material.

4. The multistage filter cartridge according to claim 1, wherein the outer filtering stage contains an antimicrobial agent.

5. The multistage filter cartridge according to claim 3, wherein the filtering material may be a scavenger material.

6. The multistage filter cartridge according to claim 1, wherein the inner filtering stage is composed of activated carbon and a binder.

7. The multistage filter cartridge according to claim 1, wherein the inner filtering stage includes a scavenger material.

8. A multistage filter cartridge, comprising:
an outer filtering stage composed of a melt blown polypropylene material having an outer surface and an inner surface;
an inner filtering stage composed of carbon and a binder material forming a carbon block having an outer surface and an inner surface; and
a void between the outer layer and the inner layer.

9. The multistage filter cartridge according to claim 8, further comprising a first end cap disposed on a top side of the multistage filter cartridge and a second end cap disposed on a bottom side of the multistage filter cartridge.

10. The multistage filter cartridge according to claim 8, wherein a filtering material is contained within the void.

11. The multistage filter cartridge according to claim 8, wherein the void contains a granular scavenger material.

12. The multistage filter cartridge according to claim 8, wherein the melt blown polypropylene material contains an antimicrobial agent.

13. The multistage filter cartridge according to claim 8, wherein the void contains granular carbon.

14. The multistage filter cartridge according to claim 8, wherein the melt blown polypropylene material contains a metal scavenging additive.

15. A multistage filter cartridge, comprising:
a generally circular outer filtering stage composed of a melt blown polypropylene material having an outer surface and an inner surface and an inner diameter and an outer diameter;
a generally circular inner filtering stage composed of carbon and a binder material forming a carbon block having an outer surface and an inner surface and an inner diameter and an outer diameter;
a first void between the inner surface of the outer layer and the outer surface of the inner layer; and
a second void within the inner surface of the carbon block.

16. The multistage filter cartridge according to claim 15, further comprising a first end cap disposed on a top side of the multistage filter cartridge and a second end cap disposed on a bottom side of the multistage filter cartridge.

17. The multistage filter cartridge according to claim 15, wherein a filtering material is contained within the first void.

18. The multistage filter cartridge according to claim 15, wherein the first void contains a granular scavenger material.

19. The multistage filter cartridge according to claim 15, wherein the melt blown polypropylene material contains an antimicrobial agent.

20. The multistage filter cartridge according to claim 15, wherein the melt blown polypropylene material contains a catalytic activated carbon.
